(19) United States
(12) Patent Application Publication
(10) Pub. No.: US 2021/0309545 A1
(43) Pub. Date: Oct. 7, 2021

(54) SYSTEM AND PROCESS FOR DESALINATING MONOVALENT ANION SPECIES FROM WASTEWATER

(71) Applicant: Saltworks Technologies, Inc., Richmond (CA)

(72) Inventors: Xiangchun Yin, Richmond (CA); Benjamin Sparrow, Richmond (CA)

(21) Appl. No.: 17/272,225

(22) PCT Filed: Oct. 31, 2019
(86) PCT No.: PCT/CA2019/051549

§ 371 Date: Feb. 26, 2021

Related U.S. Application Data
(60) Provisional application No. 62/754,068, filed on Nov. 1, 2018.

(51) Int. Cl. C02F 1/469; C02F 1/44; C02F 1/46; C02F 1/52; B01D 61/50; B01D 61/58; B01D 61/02

(52) U.S. Cl. CPC C02F 1/4693; C02F 1/442; C02F 1/4602; C02F 2101/101; B01D 61/50; B01D 61/58; B01D 61/027; C02F 1/5245

(57) ABSTRACT

Methods, systems, and techniques for desalinating monovalent anion species from wastewater. A system includes an electrodialysis stack that performs the desalination. The stack has a cathode, an anode, and at least one electrodialysis cell. The at least one electrodialysis cell includes a product chamber, a metal cation concentrating chamber adjacent to a cathodic side of the product chamber, and a transfer solution chamber adjacent to an anodic side of the product chamber. The product chamber and the metal cation concentrating chamber are each bounded by and share a cation exchange membrane, the product chamber and the transfer solution chamber are each bounded by and share a monovalent anion exchange membrane, and the transfer solution chamber is bounded on an anodic side by one of an anion exchange membrane and a monovalent anion exchange membrane. The wastewater may be generated by a flue gas desulfurization process.

### CROSS-REFERENCE TO RELATED APPLICATION

The present application claims priority to U.S. provisional patent application No. 62/754,068, filed on Nov. 1, 2018, and entitled “System and Process for Selectively Removing Monovalent Anions from Flue Gas Desulfurization Wastewater”.

### TECHNICAL FIELD

The present disclosure is directed at systems, processes, and techniques for desalinating monovalent anion species from wastewater. More particularly, a wastewater containing monovalent anion species (for example, calcium chloride) from a flue gas desulfurization process is treated by a monovalent electrodialysis system and process to selectively desalinate the monovalent anion species and to reclaim the wastewater for reuse in the flue gas desulfurization process.

### BACKGROUND

Desalination and water reuse are one way to at least partially achieve the goal of water sustainability. The most commonly practiced desalination technologies are reverse osmosis (“RO”), thermal evaporation, and electrodialysis (“ED”). In RO, water is forced through an RO membrane to generate a substantially salt-free (“pure”) water. In thermal evaporation, water is evaporated and then condensed as a distilled pure water. In ED, salt ions in water are desalinated under the influence of an electrical driving force. Unlike RO and thermal evaporation that generate a pure water, ED can produce a partially desalinated product water that retains a predetermined salt content.

### SUMMARY

According to a first aspect, there is provided a system for desalinating monovalent anion species from a wastewater, the system comprising an electrodialysis stack comprising: i) a cathode and an anode; and ii) a first electrodialysis cell between the cathode and the anode, wherein the first electrodialysis cell comprises: a) a product chamber; b) a metal cation concentrating chamber adjacent to a cathodic side of the product chamber; and c) a transfer solution chamber adjacent to an anodic side of the product chamber, wherein the product chamber and the metal cation concentrating chamber are each bounded by and share a cation exchange membrane, wherein the product chamber and the transfer solution chamber are each bounded by and share a monovalent anion exchange membrane, and wherein the transfer solution chamber is bounded on an anodic side by one of an anion exchange membrane and a monovalent anion exchange membrane.

The anodic side of the transfer solution chamber may be bounded by the anion exchange membrane, and not the monovalent anion exchange membrane.

The anodic side of the transfer solution chamber may be bounded by the monovalent anion exchange membrane, and not the anion exchange membrane.

The monovalent anion exchange membrane may have a permeability toward monovalent chloride anions over multivalent sulfate anions of at least 3.0.

The system may further comprise a multivalent anion removal unit in fluid communication with at least one of the transfer solution chamber and the metal cation concentrating chamber. The multivalent anion remove unit may be configured to remove at least some multivalent anions from a solution that has exited the at least one of the transfer solution chamber and the metal cation concentrating chamber.

The multivalent anion removal unit may comprise at least one of a multivalent anion precipitation unit and a nanofiltration unit.

The electrodialysis stack may further comprise a second electrodialysis cell adjacent to the first electrodialysis cell, the second electrodialysis cell comprising: i) a metal cation concentrating chamber adjacent to the anodic side of the transfer solution chamber of the first electrodialysis cell and sharing the one of the anion exchange membrane and the monovalent anion exchange membrane that bounds the anodic side of the transfer solution chamber of the first electrodialysis cell; ii) a product chamber adjacent to an anodic side of the metal cation concentrating chamber of the second electrodialysis cell, wherein the product chamber of the second electrodialysis cell and the metal cation concentrating chamber of the second electrodialysis cell are bounded by and share a cation exchange membrane; and iii) a transfer solution chamber adjacent to an anodic side of the product chamber of the second electrodialysis cell, wherein the product chamber of the second electrodialysis cell and the transfer solution chamber of the second electrodialysis cell are bounded by and share a monovalent anion exchange membrane.

According to another aspect, there is provided a process for desalinating monovalent anion species from a wastewater using an electrodialysis stack, the process comprising: i) directing the wastewater, a second solution and a monovalent anion transfer solution to the electrodialysis stack, the electrodialysis stack comprising: a) a cathode and an anode; and b) an electrodialysis cell between the cathode and the anode, wherein the electrodialysis cell comprises: 1) a product chamber that receives the wastewater; 2) a metal cation concentrating chamber adjacent to a cathodic side of the product chamber that receives the second solution; and 3) a transfer solution chamber adjacent to an anodic side of the product chamber that receives the monovalent anion transfer solution, wherein the product chamber and the metal cation concentrating chamber are each bounded by and share a cation exchange membrane, wherein the product chamber and the transfer solution chamber are each bounded by and share a monovalent anion exchange membrane, and wherein the transfer solution chamber is bounded on an anodic side by one of an anion exchange membrane and a monovalent anion exchange membrane; and ii) applying an electrical potential across the cathode and the anode to desalinate at least a portion of the monovalent anion species from the wastewater and to produce, from the wastewater, a product water that exits the electrodialysis stack.

The anodic side of the transfer solution chamber may be bounded by the anion exchange membrane, and not the monovalent anion exchange membrane.

The anodic side of the transfer solution chamber may be bounded by the monovalent anion exchange membrane, and not the anion exchange membrane.

The wastewater that the product chamber receives may comprise multivalent anions, and the product water may retain a least 80% of the multivalent anions of the wastewater.

The monovalent anion transfer solution exiting the electrodialysis stack may comprise multivalent anions, and the process may further comprise removing at least a portion of the multivalent anions in the monovalent anion transfer solution after exiting the electrodialysis stack to produce a regenerated monovalent anion transfer solution.

Removing of at least a portion of the multivalent anions from the monovalent anion transfer solution may be performed by at least one of separating the multivalent anions through a nanofiltration process and precipitating the multivalent anions from the monovalent anion transfer solution.

Precipitating multivalent anions may be performed by adding at least one of barium chloride and barium hydroxide to the monovalent anion transfer solution after the monovalent anion transfer solution exits the transfer solution chamber.

The process may further comprise directing the regenerated monovalent anion transfer solution to the transfer solution chamber.

Monovalent anion species removed from the wastewater may be concentrated in the second solution during desalination to produce a monovalent anion concentrate solution that also comprises multivalent anions, and the process may further comprise removing at least a portion of the multivalent anions from the monovalent anion concentrate solution after the monovalent anion concentrate solution exits the electrodialysis stack.

The process may further comprise recirculating the monovalent anion concentrate solution after removing at least a portion of the multivalent anions to the metal cation concentrating chamber.

The wastewater may be generated by a flue gas desulfurization process.

The process may further comprise reusing the product water as a makeup water for the flue gas desulfurization process.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a schematic diagram illustrating a conventional (prior art) monovalent electrodialysis stack, which may be used for treating a flue gas desulfurization wastewater to a limited degree.

FIG. 2 is a schematic diagram illustrating one example embodiment of a monovalent electrodialysis stack, which may be used for treating a flue gas desulfurization wastewater.

FIG. 3 is a schematic diagram illustrating another example embodiment of the monovalent electrodialysis stack, which may be used for treating a flue gas desulfurization wastewater.

FIG. 4 is a schematic diagram illustrating an example embodiment of a desalination system, which may be used to treat a flue gas desulfurization wastewater using either of the monovalent electrodialysis stacks shown in FIGS. 2 and 3.

For the sake of clarity, not every component is labeled, nor is every component of each embodiment shown where illustration is unnecessary to allow those of ordinary skill in the art to understand the embodiments described herein.

### DETAILED DESCRIPTION

As used in this disclosure:
“Monovalent anion species” refers to salt or acid compounds comprising monovalent anions and at least one of monovalent and multivalent cations.
“Monovalent ion species” refers to salt or acid compounds comprising monovalent anions and monovalent cations.
“Multivalent anion species” refers to salt or acid compounds comprising multivalent anions and at least one of monovalent and multivalent cations.
A “cation exchange membrane” refers to an ion exchange membrane that is permeable to cations (both monovalent and multivalent cations) and substantially impermeable to, and in some embodiments and depending on operating conditions entirely impermeable to, anions. “Substantially” in this context means the membrane is impermeable to at least 80% of the anions that attempt to permeate through it.
An “anion exchange membrane” refers to an ion exchange membrane that is permeable to anions (both monovalent and multivalent anions) and substantially impermeable to, and in some embodiments and depending on operating conditions entirely impermeable to, cations. “Substantially” in this context means the membrane is impermeable to at least 80% of the cations that attempt to permeate through it.
A “monovalent anion exchange membrane” refers to an anion exchange membrane that is more permeable to monovalent anions than multivalent anions, and that is substantially impermeable to, and in some embodiments and depending on operating conditions entirely impermeable to, cations. “Substantially” in this context means the membrane is impermeable to at least 80% of the cations that attempt to permeate through it. “More permeable” in this context means, when monovalent and multivalent anions at the same molar equivalents are desalinated by electrodialysis, the permeability ratio of monovalent anions over multivalent anions is greater than 1, is preferably greater than 5, and is more preferably greater than 10.

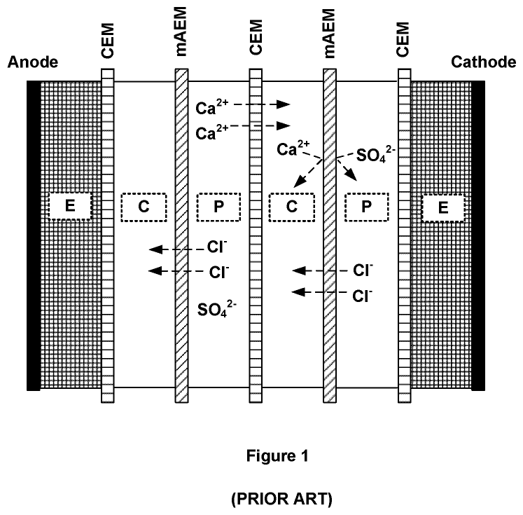

As used in this disclosure and in FIGS. 1 to 3:
“C” refers to a concentrate solution generated during electrodialysis that receives salt ions that migrate in response to an electrical driving force during desalination (“desalinated salt ions”).
“E” refers to an electrolyte solution used during electrodialysis.
“P” refers to a at least partially desalinated product water, which is generated during electrodialysis.
“R” refers to a rinse solution used during electrodialysis.
“T” refers to a monovalent anion transfer solution used during electrodialysis.

The combustion of coal in coal-fired power plants generates sulfur dioxide-contaminated flue gas. Before being emitted into the atmosphere, the flue gas is generally treated by a process of flue gas desulfurization (“FGD”) to remove the sulfur dioxide. One common FGD process is based on wet scrubbing where a limestone slurry is used to scrub the sulfur dioxide out of the flue gas. The wet FGD scrubbing generates a wastewater comprising metal cations (for example, sodium, calcium, and magnesium), monovalent anions (for example, chloride and nitrate) and multivalent anions (for example, sulfate). After removing the FGD wastewater's suspended solids (for example, calcium sulfate solid and coal ash), the FGD wastewater is first reused as a makeup water for the limestone slurry, which is used to further scrub the sulfur dioxide. Sulfate and calcium in the FGD wastewater are mostly removed from the FGD wastewater during the FGD process as calcium sulfate precipitates. However, soluble monovalent anions, such as chloride, accumulate in the FGD wastewater as it is reused as the makeup water for the limestone slurry. High chloride concentrations in the limestone slurry inhibit sulfur dioxide scrubbing and pose a corrosion risk for equipment in the FGD process. The FGD wastewater must accordingly be eventually purged out of the FGD process when its chloride concentration exceeds a preset level (for example, around 8,000 mg/L). A wastewater treatment that can remove chloride out of the FGD process will improve FGD wastewater reuse and reduce the amount of FGD wastewater that needs to be discharged into the environment.

In some desalination applications where generating a pure water is unnecessary and economically unacceptable, such as when desalinating FGD wastewater, the partial desalination permitted by an ED process is advantageous as compared to RO and thermal evaporation processes. ED has a further advantage compared to these other processes in that it permits use of highly permselective monovalent ion exchange membranes, which are able to selectively desalinate specific ions such as monovalent ions to produce a partially desalinated product water that is tailored to meet the requirements of specific use cases. Accordingly, in at least some of the embodiments described herein, an ED process is used in conjunction with monovalent anion exchange membranes to disproportionately remove chloride relative to sulfate from an FGD wastewater generated from a flue gas desulfurization process.

Turning first to FIG. 1, there is shown schematically a conventional (prior art) monovalent electrodialysis (“mED”) stack, which may be used to remove monovalent anions, such as chloride, from an FGD wastewater to a limited degree. The conventional mED stack comprises alternating monovalent anion exchange membranes (each an “mAEM”) and cation exchange membranes (each a “CEM”) between two electrodes (an anode and a cathode), and alternating product chambers (“P-chambers”) and concentrate chambers (“C-chambers”) bounded by CEMs and mAEMs between two end electrolyte chambers (“E-chambers”). Each electrodialysis cell comprises a P-chamber and a neighboring C-chamber, which are separated by an mAEM. During operation, an FGD wastewater comprising calcium, chloride, and sulfate ions may be fed through the P-chambers and a second water carrying away desalinated salt ions may be fed through the C-chambers. Monovalent anions, such as chloride, in the FGD wastewater flowing in the P-chambers migrate toward the anode and cross mAEMs bounding the anodic side of the P-chambers into the second water flowing in the C-chambers. Simultaneously, cations, such as calcium, in the FGD wastewater flowing in the P-chambers migrate toward the cathode and cross CEMs bounding the cathodic side of the P-chambers into the second water flowing in the C-chambers. Sulfate in the FGD wastewater is stopped by the mAEMs and is retained in the P-chambers. The conventional mED stack shown in FIG. 1 can in theory separate, to a certain degree, calcium and sulfate into C-chambers and P-chambers, respectively.

However, it has been experimentally found that while desalinating an FGD wastewater using the conventional mED stack of FIG. 1, calcium sulfate precipitated onto the surface of and inside the conventional mED stack's mAEMs, thereby scaling the mAEMs. The calcium sulfate scaling led to the eventual breakdown of mAEMs inside the conventional mED stack and the interruption of desalination. Without being limited to a specific theory, the scaling of calcium sulfate may be caused by increasing the calcium sulfate concentration above its solubility in solutions around the mAEM boundary layer and inside the mAEMs. More importantly, both calcium ions and sulfate under the influence of an electrical driving force run against mAEMs bounding each of and between the P-chambers and the C-chambers in the conventional mED stack of FIG. 1. The mAEMs in theory should stop calcium ions and sulfate ions from meeting each other. However, practically, the permselectivities of mAEMs for anions over cations and for monovalent anions over multivalent anions are not perfect and cannot provide a calcium-proof and sulfate-proof barrier to prevent the calcium ions and sulfate from meeting. Some of the calcium ions and sulfate in solution under the influence of an electrical driving force accordingly enter and cross the mAEMs to meet each other, thereby forming calcium sulfate scaling on the surface of and inside the mAEMs.

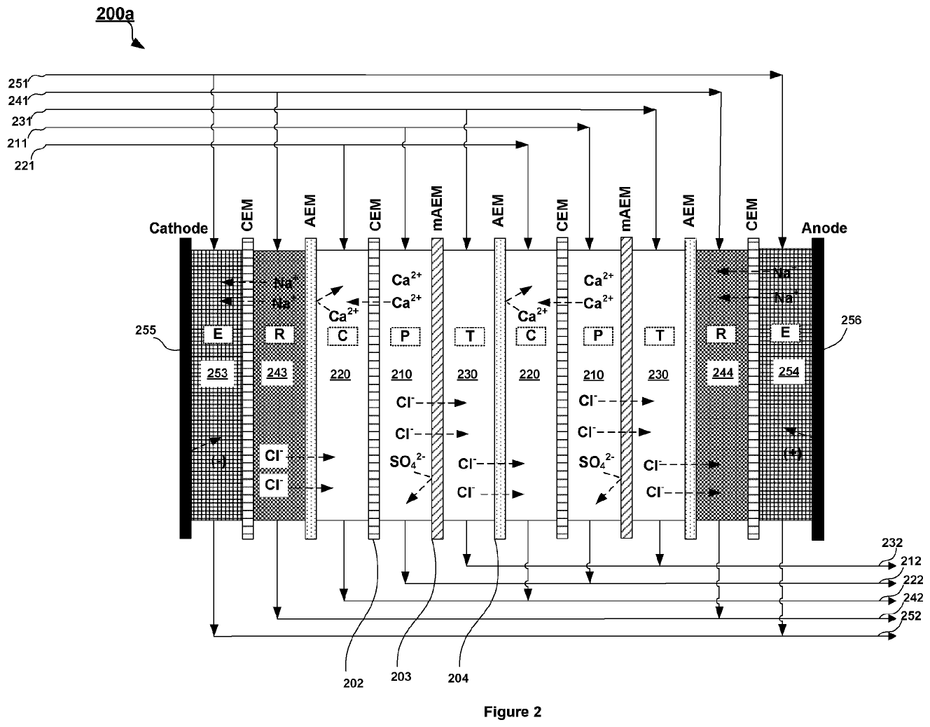

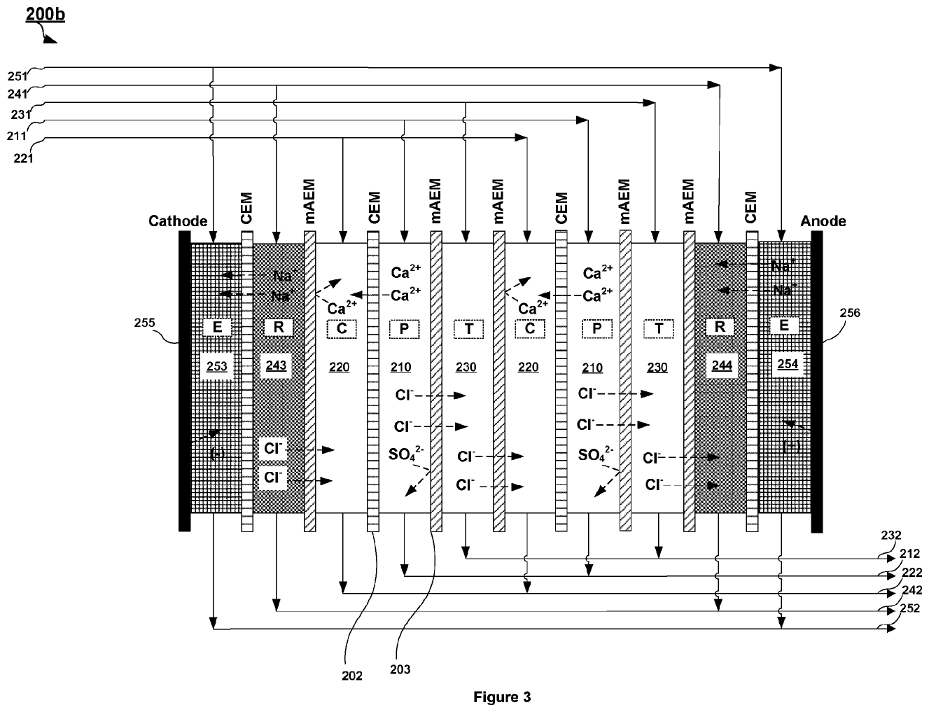

Turning now to FIGS. 2 and 3, there are respectively shown schematically first and second example embodiments of an mED stack 200a and 200b (collectively, “stacks 200a,b”), which are used to treat a flue gas desulfurization wastewater. As discussed further below, this is done without calcium sulfate scaling the surface and interior of the stacks' 200a,b mAEMs.

Compared to the conventional mED stack shown in FIG. 1 in which each electrodialysis cell only comprises a neighboring P-chamber and C-chamber, each electrodialysis cell in the stacks 200a,b comprises three chambers: a P-chamber, a C-chamber, and a monovalent anion transfer solution chamber (“T-chamber”). The first embodiment of the stack 200a comprises at least three types of ion exchange membranes separating its chambers: CEMs 202, mAEMs 203, and anion exchange membranes 204 (each an “AEM 204”). The stack 200b comprises at least two types of ion exchange membranes separating its chambers: CEMs 202 and mAEMs 203. In at least some embodiments, when used to treat an FGD wastewater, the stacks 200a,b rely on the permeability of mAEMs 203 toward monovalent chloride anions over multivalent sulfate anions to prevent calcium sulfate scaling. The mAEMs 203 have a permeability toward monovalent chloride anions over multivalent sulfate anions of at least 3.0.

On one end of the stacks 200a,b is a cathodic E-chamber 253 bounded by a cathode 255 on one side and a cathodic electrolyte cation exchange membrane on the other side, and on the other end of the stacks 200a,b is an anodic E-chamber 254 bounded by an anode 256 on one side and an anodic electrolyte cation exchange membrane on the other side. During stack operation, an electrolyte solution is pumped via conduit 251 into the E-chambers 253,254, and the electrolyte solution exits the E-chambers 253,254 via conduit 252. Example electrolytes may include aqueous sodium sulfate and aqueous potassium nitrate solutions. A direct current power supply (not shown in FIGS. 2 and 3) applies an electric potential (voltage) across the cathode 255 and the anode 256.

Adjacent to the E-chambers 253,254, and separated from them by one of the electrolyte cation exchange membranes, are a first and a second rinse solution chamber (“R-chamber”) 243,244, respectively. While the stacks 200a,b include the R-chambers 243,244, in at least some alternative embodiments (not shown), the stacks 200a,200b may omit the R-chambers 243,244. During stack operation, a rinse solution enters the R-chambers 243,244 via conduit 241 and exits via conduit 242. Example rinse solutions may include aqueous sodium chloride and potassium chloride solutions. The R-chambers 243,244 protect the E-chambers 253,254 from pollution by divalent scaling ions such as calcium and magnesium.

Each of the stacks 200a,b comprises, between the cathode 255 and the anode 256, at least a first electrodialysis cell comprising a) a P-chamber 210, b) a metal cation C-chamber 220 adjacent to the cathodic side of the P-chamber 210, and c) a T-chamber 230 adjacent to the anodic side of the P-chamber 210, wherein the P-chamber 210 and the metal cation C-chamber 220 are each bounded by and share a cation exchange membrane 202, and the P-chamber 210 and the T-chamber 230 are each bounded by and share a monovalent anion exchange membrane 203. In the first embodiment of the stack 200a as depicted in FIG. 2, the T-chamber 230 is bounded on its anodic side by an anion exchange membrane 204. In the second embodiment of the stack 200b as depicted in FIG. 3, the T-chamber 230 is bounded on its anodic side by a monovalent anion exchange membrane 203.

As depicted, the stacks 200a,b also comprise a second electrodialysis cell positioned adjacent to the first electrodialysis cell, wherein the second electrodialysis cell comprises a) a metal cation C-chamber 220 adjacent to the anodic side of and sharing one of the anion exchange membrane 204 (in the first embodiment of the stack 200a) and the monovalent anion exchange membrane 203 (in the second embodiment of the stack 200b) with the T-chamber 230 of the first electrodialysis cell, b) a P-chamber 210 adjacent to the anodic side of and sharing a cation exchange membrane 202 with the metal cation C-concentrating chamber 220 of the second electrodialysis cell, and c) a T-chamber 230 adjacent to the anodic side of and sharing an mAEM 203 with the P-chamber 210 of the second electrodialysis cell.

The stacks 200a,b may comprise repeating electrodialysis cells, with each such electrodialysis cell comprising three chambers separated by ion exchange membranes having at least one of the following configurations:
(i) AEM 204/metal cation C-chamber 220/CEM 202/P-chamber 210/mAEM 203/T-chamber 230 (shown by the first embodiment of the stack 200a, depicted in FIG. 2);
(ii) metal cation C-chamber 220/CEM 202/P-chamber 210/mAEM 203/T-chamber 230/AEM 204 (shown by the first embodiment of the stack 200a, depicted in FIG. 2);
(iii) mAEM 203/metal cation C-chamber 220/CEM 202/P-chamber 210/mAEM 203/T-chamber 230 (shown by the second embodiment of the stack 200b, depicted in FIG. 3); and
(iv) metal cation C-chamber 220/CEM 202/P-chamber 210/mAEM 203/T-chamber 230/mAEM 203 (shown by the second embodiment of the stack 200b, depicted in FIG. 3).

During stack operation, a wastewater (for example, an FGD wastewater) comprising metal cations (for example, sodium, calcium and magnesium), monovalent anions (for example, chloride and nitrate) and multivalent anions (for example, sulfate) is directed via conduit 211 to the P-chambers 210; a second solution receiving desalinated salt ions from the wastewater is directed via conduit 221 to the metal cation C-chambers 220; and a monovalent anion transfer solution comprising monovalent ion species (for example, sodium chloride) is directed via conduit 231 to the T-chambers 230. Under the influence of an applied electric potential, the metal cations (for example, calcium) in the wastewater flowing in the P-chambers 210 migrate across the CEM 202 bounding the cathodic side of the P-chambers 210 and into the second solution flowing in the metal cation concentrating chambers 220. Monovalent anions (for example, chloride) in the wastewater flowing in the P-chambers 210 migrate across the mAEM 203 bounding the anodic side of the P-chambers 210 and into the monovalent anion transfer solution flowing in the T-chambers 230. Multivalent anions (for example, sulfate) in the wastewater, however, do not cross the mAEM 203 bounding the anodic side of the P-chambers 210 and consequently are retained in the P-chambers 210. A portion of the monovalent anions (for example, chloride) in the monovalent anion transfer solutions flowing in the T-chambers 230, which may be received from the wastewater or from the monovalent ion species, migrates across the AEM 204 (for the first embodiment of the stack 200a) or across the mAEM 203 (for the second embodiment of the stack 200b) bounding the anodic side of the T-chambers 230 and into the second solution flowing in the metal cation C-chambers 220. The cations of the monovalent ion species in the monovalent anion transfer solution do not cross the AEM 204 or the mAEM 203 and consequently are retained in the T-chambers 230. As a result, the wastewater is selectively desalinated in monovalent anion species (for example, calcium chloride) and becomes a partially desalinated product water with monovalent anion species (for example, calcium chloride) at least partially depleted while retaining at least 80% of its multivalent anions (for example, sulfate). The product water exits via conduit 212 from the P-chambers 210. The second solution flowing through the metal cation C-chambers 220 receives monovalent anion species comprising metal cations from the wastewater and monovalent anions from the monovalent anion transfer solution and becomes a concentrate solution enriched with monovalent anion species. The concentrate solution enriched with monovalent anion species exits via conduit 222 from the metal cation concentrating chambers 220. The monovalent anion transfer solution flowing through the T-chambers 230 serves as an intermediate solution for ion transfer and balances its ion-charge neutrality by receiving and transferring out the same molar equivalent of anions. The monovalent anion transfer solution exits via conduit 232 from the T-chambers 230 and is reused by circulating it back to the T-chambers 230.

Compared to the conventional mED stack shown in FIG. 1, each electrodialysis cell of the stacks 200a,b shown in FIGS. 2 and 3 comprises a T-chamber 230 seated between a P-chamber 210 and a metal cation C-chamber 220. In addition, the T-chamber 230 is bounded on its cathodic side by an mAEM 203 and on its anodic side by an AEM 204 (for the first embodiment of the stack 200a) or an mAEM 203 (for the second embodiment of the stack 200b). Using the T-chamber 230 and its two bounding membranes addresses the issue of calcium sulfate scaling onto the surface of and inside the mAEMs 203. In the conventional mED stack shown in FIG. 1, calcium and sulfate run under the influence of an electrical driving force against the mAEMs, causing calcium sulfate scaling. In contrast, calcium and sulfate according to the embodiments of the stacks 200a,b in FIGS. 2 and 3 are separated by two different membranes bounding the T-chamber 230. The chances of coupling calcium and sulfate to form scaling calcium sulfate are accordingly significantly reduced. Using the T-chamber 230 between the P-chamber 210 and the metal cation C-chamber 220 also prevents possible calcium sulfate scaling caused by internal leakage (for example leakage caused by membrane pinholes or bad stack sealing) between the P-chambers 210 and the metal cation C-chambers 220. If internal leakage takes place, the monovalent anion transfer solution flowing in the T-chamber 230 may be refreshed partially or completely with a makeup monovalent anion transfer solution.

The stack 200b in FIG. 3 provides an additional barrier to prevent sulfate from meeting calcium by bounding the T-chamber 230 with two mAEMs 203. The stack 200b can also be operated in a mode of monovalent electrodialysis reversal (mEDR) to remove any scaling that has built up onto membrane surfaces by switching the polarity of the potential applied to the electrodes 255,256 while simultaneously swapping the fluids flowing between the P-chamber 210 and metal cation C-chamber 220.

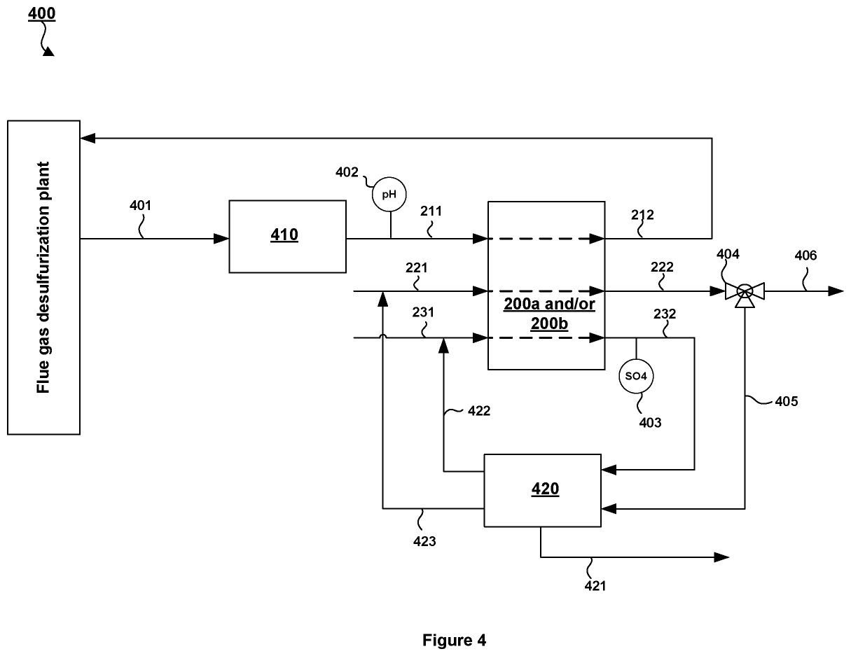

FIG. 4 illustrates, according to one example embodiment, a monovalent anion desalination system 400 that selectively desalinates monovalent anion species from an FGD wastewater. The system 400 is used in conjunction with an FGD plant, which produces the FGD wastewater and reuses a partially desalinated product water resulting from the selective desalination as a makeup water for limestone slurry. The system 400 uses at least one of the stacks 200a,b as illustrated in FIGS. 2 and 3. The one or more stacks 200a,b remove and concentrate monovalent anion species from the FGD wastewater as described above in respect of FIGS. 2 and 3. The system 400 further comprises a pretreatment unit 410 in fluid communication with the FGD plant and with the at least one stack 200a,b, and a multivalent anion removal unit 420 in fluid communication with at least one of the T-chambers 230 and the metal cation C-chambers 220 of the at least one stack 200a,b.

The system 400 shown in FIG. 4 is operated in a continuous manner; however, in different embodiments (not depicted), the system 400 may be operated in a batch manner or a semi-batch manner by controlling suitable valves, conduits, tanks and pumps (not shown in FIG. 4).

An FGD wastewater comprising metal cations (for example, sodium, calcium and magnesium), monovalent anions (for example, nitrate and chloride) and multivalent anions (for example, sulfate) is directed via conduit 401 to the pretreatment unit 410, where the FGD wastewater is pretreated through one or more of sulfate desaturation (for example, precipitating calcium sulfate by adding lime), heavy metal removal (for example, precipitating heavy metal compounds by adding lime and/or organosulfide compounds), fluoride removal by adding lime, and solid separation by one or more of hydrocyclone, coagulation, flocculation, gas flotation, clarification, sedimentation, media filtration, microfiltration, and ultrafiltration.

The concentrations of heavy metals (for example, zinc, iron, and mercury) in the pretreated wastewater are monitored. When the concentrations of any one or more heavy metals are above a preset value (for example, if zinc content is above 1.0 mg/L), the pretreated wastewater may be further treated by adding a base (for example, sodium hydroxide or calcium hydroxide) to the wastewater until its pH is above 9.0, thereby precipitating heavy metals as one or more metal hydroxide compounds.

The pH of the pretreated wastewater before being fed via conduit 211 to at least one of the stacks 200a,b is monitored by a pH monitor 402. An acid addition unit (for example, an acid solution container coupled with a control valve, not shown in FIG. 4) may supply an acid solution (for example, hydrochloric acid or sulfuric acid solution) to the pretreated wastewater to adjust its pH to below 7.0, preferably to below 5.0, and more preferably to below 3.0. The acidic pH helps remove any bicarbonate/carbonate in the pretreated wastewater and prevent the scaling of metal fluoride (such as calcium fluoride) during monovalent electrodialysis.

When the system 400 is used to remove monovalent anion species, at least three solutions are directed to the at least one stack 200a,b: the pretreated FGD wastewater via conduit 211, a second solution to receive the desalinated ions from the FGD wastewater via conduit 221, and a monovalent anion transfer solution via conduit 231. As described above in respect of FIGS. 2 and 3, the at least one stack 200a,b selectively desalinates the monovalent anion species from the FGD wastewater and produces a partially desalinated product water with monovalent anion species (for example, calcium chloride) at least partially depleted while retaining at least 80% of the wastewater's multivalent anions (for example, sulfate ions). The product water exits via conduit 212 from the P-chambers 210. The second solution receiving the desalinated ions from the wastewater becomes a concentrate solution enriched with monovalent anion species. The concentrate solution exits via conduit 222 from the at least one stack 200a,b. Once the monovalent anions' concentration in the product water is desalinated to a preset value, the product water is directed back to the FGD plant and reused as a makeup water for limestone slurry.

While selectively desalinating using the system 400, some of the multivalent anions in the FGD wastewater may leak through the mAEMs 203 and into the monovalent anion transfer solution, for example because the mAEMs 203 cannot perfectly reject all multivalent anions or because there is internal leakage (for example leakage caused by membrane pinholes or bad stack sealing) inside the at least one stack 200a,b. The concentration of the multivalent anions (for example, sulfate) in the monovalent anion transfer solution exiting via conduit 232 from the at least one stack 200a,b is measured by an online multivalent anion monitor 403 or by an offline multivalent anion measurement apparatus after sampling the monovalent anion transfer solution that has exited the at least one stack 200a,b. When the multivalent anion concentration reaches a preset value (for example, 500 mg/L), the monovalent anion transfer solution that has exited the T-chamber 230 of the at least one stack 200a,b is partially or completely directed via conduit 232 to the multivalent anion removal unit 420 for multivalent anion removal. The multivalent anion removal unit 420 removes at least some of the multivalent anions in the received monovalent anion transfer solution and produces a regenerated monovalent anion transfer solution with multivalent anions being partially or completely depleted. The regenerated monovalent anion transfer solution is directed via conduits 422 and 231 back to the T-chamber 230 and is reused as monovalent anion transfer solution for the at least one stack's 200a,b operation. The multivalent anion removal unit 420 also discharges via conduit 421 the removed multivalent anion species from the system 400 or back to the wastewater (not shown in FIG. 4) as it exits the flue gas desulfurization plant for further treatment. The removal of multivalent anions from the monovalent anion transfer solution can be performed in at least one of a batch mode, a semi-batch mode, and a continuous mode by controlling suitable valves, conduits, and pumps.

In one embodiment, the multivalent anion removal unit 420 is a multivalent anion precipitation unit. A multivalent anion precipitation chemical (for example, barium chloride or barium hydroxide) is added by a chemical addition unit (for example, a precipitant container coupled with a control valve, not shown in FIG. 4) to the multivalent anion removal unit 420 in order to precipitate multivalent anions from the monovalent anion transfer solution. The reaction in the multivalent anion precipitation unit produces multivalent anion precipitates (for example, barium sulfate) discharged via conduit 421 from of the system 400 and a regenerated monovalent anion transfer solution with multivalent anions partially or completely depleted therefrom. The regenerated monovalent anion transferring soliton is directed via conduits 422 and 231 back to the T-chamber 230 in the at least one stack 200a,b for reuse as a monovalent anion transfer solution.

In another embodiment, the multivalent anion removal unit 420 is a nanofiltration unit. The nanofiltration unit comprises a nanofiltration membrane with more than 90% rejection efficiency for multivalent anions species (for example, sodium sulfate), but less than 60% rejection efficiency for monovalent anion species (for example, sodium chloride). Example suitable nanofiltration membranes include certain organic membranes (for example, polymeric membranes) and inorganic membranes (for example, metallic, silica, ceramic, carbon, zeolite, oxide or glass membranes). The nanofiltration membrane unit may use any suitable configuration. Examples of suitable membrane configurations may depend, in part, on the membrane material, and may include flat sheet, spiral wound, tubular, and hollow-fiber membrane. The nanofiltration unit produces a multivalent anion species-containing retentate discharged via conduit 421 from the system 400 or recycled to the wastewater fed to the at least one stack 200a,b for further treatment (this recycling is not shown in FIG. 4), and a permeate with multivalent anions being partially or completely depleted. The nanofiltration permeate is used as a regenerated monovalent anion transfer solution directed via conduits 422 and 231 back to the T-chamber 230 in the at least one stack 200a,b for reuse as a monovalent anion transfer solution.

The concentrate solution enriched with monovalent anion species from the at least one stack 200a,b is discharged from the system 400 via control valve 404 and conduit 406. The discharged concentrate solution enriched with monovalent anion species may be disposed by mixing it with a coal ash or a cement to in certain embodiments, achieve zero-liquid discharge. Alternatively, the concentrate solution enriched with monovalent anion species from the at least one stack 200a,b may be recirculated via control valve 404, and conduits 405, 423, and 221 back to the at least one stack 200a,b for further concentrating of monovalent anion species. The recirculated concentrate solution may be treated by the multivalent anion removal unit 420 to remove any multivalent anions. The multivalent anion removal process is as described above in respect of the multivalent anion removal unit 420, which may be selected from at least one of a multivalent anion precipitation unit and nanofiltration unit.

It is contemplated that any part of any aspect or embodiment discussed in this specification can be implemented or combined with any part of any other aspect or embodiment discussed in this specification.

One or more example embodiments have been described by way of illustration only. This description is presented for purposes of illustration and description, but is not intended to be exhaustive or limited to the form disclosed. It will be apparent to persons skilled in the art that a number of variations and modifications can be made without departing from the scope of the claims.

1. A system for desalinating monovalent anion species from a wastewater, the system comprising an electrodialysis stack comprising:
i) a cathode and an anode; and
ii) a first electrodialysis cell between the cathode and the anode, wherein the first electrodialysis cell comprises:
a) a product chamber;
b) a metal cation concentrating chamber adjacent to a cathodic side of the product chamber; and
c) a transfer solution chamber adjacent to an anodic side of the product chamber,
wherein the product chamber and the metal cation concentrating chamber are each bounded by and share a cation exchange membrane, wherein the product chamber and the transfer solution chamber are each bounded by and share a monovalent anion exchange membrane, and wherein the transfer solution chamber is bounded on an anodic side by one of an anion exchange membrane and a monovalent anion exchange membrane.

2. The system of claim 1, wherein the anodic side of the transfer solution chamber is bounded by the anion exchange membrane.

3. The system of claim 1, wherein the anodic side of the transfer solution chamber is bounded by the monovalent anion exchange membrane.

4. The system of claim 1, wherein the monovalent anion exchange membrane has a permeability toward monovalent chloride anions over multivalent sulfate anions being at least 3.0.

5. The system of claim 1, further comprising a multivalent anion removal unit in fluid communication with at least one of the transfer solution chamber and the metal cation concentrating chamber, the multivalent anion removal unit configured to remove at least some multivalent anions from a solution that has exited the at least one of the transfer solution chamber and the metal cation concentrating chamber.

6. The system of claim 5, wherein the multivalent anion removal unit comprises at least one of a multivalent anion precipitation unit and a nanofiltration unit.

7. The system of claim 1, wherein the electrodialysis stack further comprises a second electrodialysis cell adjacent to the first electrodialysis cell, the second electrodialysis cell comprising:
i) a metal cation concentrating chamber adjacent to the anodic side of the transfer solution chamber of the first electrodialysis cell and sharing the one of the anion exchange membrane and the monovalent anion exchange membrane that bounds the anodic side of the transfer solution chamber of the first electrodialysis cell;
ii) a product chamber adjacent to an anodic side of the metal cation concentrating chamber of the second electrodialysis cell, wherein the product chamber of the second electrodialysis cell and the metal cation concentrating chamber of the second electrodialysis cell are bounded by and share a cation exchange membrane; and
iii) a transfer solution chamber adjacent to an anodic side of the product chamber of the second electrodialysis cell, wherein the product chamber of the second electrodialysis cell and the transfer solution chamber of the second electrodialysis cell are bounded by and share a monovalent anion exchange membrane.

8. A process for desalinating monovalent anion species from a wastewater using an electrodialysis stack, the process comprising:
i) directing the wastewater, a second solution and a monovalent anion transfer solution to the electrodialysis stack, the electrodialysis stack comprising:
a) a cathode and an anode; and
b) an electrodialysis cell between the cathode and the anode, wherein the electrodialysis cell comprises:
1) a product chamber that receives the wastewater;
2) a metal cation concentrating chamber adjacent to a cathodic side of the product chamber that receives the second solution; and
3) a transfer solution chamber adjacent to an anodic side of the product chamber that receives the monovalent anion transfer solution,
wherein the product chamber and the metal cation concentrating chamber are each bounded by and share a cation exchange membrane,
wherein the product chamber and the transfer solution chamber are each bounded by and share a monovalent anion exchange membrane, and
wherein the transfer solution chamber is bounded on an anodic side by one of an anion exchange membrane and a monovalent anion exchange membrane; and
ii) applying an electric potential across the cathode and the anode to desalinate at least a portion of the monovalent anion species from the wastewater and to produce, from the wastewater, a product water that exits the electrodialysis stack.

9. The process of claim 8, wherein the anodic side of the transfer solution chamber is bounded by the anion exchange membrane.

10. The process of claim 8, wherein the anodic side of the transfer solution chamber is bounded by the monovalent anion exchange membrane.

11. The process of claim 8, wherein the wastewater that the product chamber receives comprises multivalent anions, and wherein the product water retains at least 80% of the multivalent anions of the wastewater.

12. The process of claim 11, wherein the monovalent anion transfer solution exiting the electrodialysis stack comprises multivalent anions, and wherein the process further comprises removing at least a portion of the multivalent anions in the monovalent anion transfer solution after exiting the electrodialysis stack to produce a regenerated monovalent anion transfer solution.

13. The process of claim 12, wherein the removing of at least a portion of the multivalent anions from the monovalent anion transfer solution is performed by at least one of separating the multivalent anions through a nanofiltration process and precipitating the multivalent anions from the monovalent anion transfer solution.

14. The process of claim 13, wherein the precipitating of multivalent anions is performed by adding at least one of barium chloride and barium hydroxide to the monovalent anion transfer solution after the monovalent anion transfer solution exits the transfer solution chamber.

15. The process of claim 12, further comprising directing the regenerated monovalent anion transfer solution to the transfer solution chamber.

16. The process of claim 8, wherein the monovalent anion species removed from the wastewater are concentrated in the second solution during desalination to produce a monovalent anion concentrate solution that also comprises multivalent anions, and further comprising removing at least a portion of the multivalent anions from the monovalent anion concentrate solution after the monovalent anion concentrate solution exits the electrodialysis stack.

17. The process of claim 16, further comprising recirculating the monovalent anion concentrate solution after removing at least a portion of the multivalent anions to the metal cation concentrating chamber.

18. The process of claim 8, wherein the wastewater is generated by a flue gas desulfurization process.

19. The process of claim 18, further comprising reusing the product water as a makeup water for the flue gas desulfurization process.
